(19) United States
(12) Patent Application Publication
(10) Pub. No.: US 2015/0298372 A1
(43) Pub. Date: Oct. 22, 2015

(54) LIGHT HEADREST OPTIMIZED FOR PRODUCTION RESOURCES AND ASSOCIATED METHOD

(71) Applicant: ILLINOIS TOOL WORKS INC., Glenview, IL (US)

(72) Inventors: Jordi BIELSA, Folgueroles (ES); Alberto LARDIES, Les Franqueses (ES); Ricard FORTUNY, Sabadell (ES)

(21) Appl. No.: 14/405,801

(22) PCT Filed: Jun. 11, 2013
(86) PCT No.: PCT/US2013/045207

§ 371 Date: Dec. 5, 2014

(30) Foreign Application Priority Data
Jun. 13, 2012 (ES) 201230928

(51) Int. Cl. B29C 45/14; B60N 2/48

(52) U.S. Cl. CPC B29C 45/14467; B60N 2/48; B29K 2705/00

(57) ABSTRACT

Light headrest optimised for production resources, comprising a head piece and bars made by overmolding on rigid cores, where said headrest is a single-piece structural body that comprises the bars and the head piece. Method for obtaining the headrest comprising the stages: (i) coupling the two rigid cores inside the injection mold having the final shape of the headrest; (ii) injecting the fused material in the mold and overmolding on the rigid cores; (iii) opening the mold and extracting the finished headrest; (iv) placing polymeric foam in the empty spaces of the single-piece structural body.

### OBJECT OF THE INVENTION

The present invention is applicable in the automobile sector, and relates to a light headrest optimised for production resources that allows optimising the use of the materials in its manufacture and simplifying the manufacturing process, as well as improving the resistance against impact compared to current headrests, while contributing to reducing CO2 emissions according to new European regulations.

More specifically, the object of the invention is a headrest that allows reducing the number of stages of the manufacturing and assembly process by its manufacture in a single stage, as well as a selective use of its materials with the resulting reduction in manufacturing costs, in addition increasing the resistance of the structure and improving its capacity to withstand greater loads than currently used headrests, with a lower weight that contributes to reducing the total weight of the interior of a vehicle, as well as a versatile and integrated design.

### BACKGROUND OF THE INVENTION

Currently, one of the undesirable complications in the automobile sector is the high cost of automobiles with improved performance. This is because the technological advances incorporated in automobiles generally increase the total cost of automobiles.

Specifically, the variations and technological advances have an impact on the production chain. This means that these advances must go hand in hand with a rigorous optimisation of production times in dynamic automobile assembly chains, which by nature are highly inflexible and must comply with the daily production set to cover demand, and are currently the object of active research and investment of many resources, implementing many different tools, approaches and management methods to reduce these production times as much as possible. Any unexpected stoppages in the assembly chain or slight increases in production times represent a considerable reduction of automobiles, which translates into financial losses.

Another problem faced by the automobile industry is excessive emissions of CO2 to the atmosphere. These CO2emissions result from the release of internal combustion engine exhaust gases to the environment, so that the heavier the vehicle the more power it will need to start moving, for example, therefore increasing its fuel consumption and increasing its CO2 emissions. To reduce the weight of automobiles, research is currently underway meant to find new internal components that are as light as possible to replace the automobile interior components used at this time.

To solve some aspects of the problems discussed above, a known solution is disclosed in patent ES 2106489 (T3) for a headrest frame with a strong and lightweight structure that acts as a support for the headrest on the vehicle seat backrest in a firm and vibration-free manner. This frame is mainly composed of two lateral bars and a crossbar made of plastic, with metal rods or cores inside them. This invention relates to a frame but does not include the corresponding headrest. In this sense, the installation of the frame must be integrated in some assembly stage of the automobile interior, which requires labor specialised in this task and therefore increases the cost by increasing the production time and therefore reducing the production, with the risk of stopping the production chain due to the inclusion of these assembly operations for the automobile interior that generally depend on one worker.

Another solution for optimising the materials and achieving the corresponding reduction in cost and weight of this type of interior components consists of the method disclosed in document U.S. Pat. No. 6,631,956, which describes a manufacturing method for this type of component with a metal core over-injected with plastic. This method consists of obtaining the metal bars with the desired shape after a bending process, placing them in the injection mold and finally injecting the plastic in the mold such that the metal bars end up in the core of the structure. Although this document provides a solution for optimising the materials used in the manufacturing process of a headrest, it does not allow reducing the assembly stages and therefore does not provide a reduced time of assembly and lower production costs.

In light of the above, the inventions included in the prior art provide the function of the subject matter of the invention only in part, while in an unreliable and non-versatile manner, as headrests hitherto manufactured with these specific features of an optimum material with metal rods embedded in plastic bars that allow reducing vibrations, do not allow reducing the stages of the production stage and do not allow reducing the weight of the headrest as a whole other than in the reduction achieved by this optimised use of metal and plastic.

### DESCRIPTION OF THE INVENTION

The present invention relates to a light headrest optimised for production resources that solves the drawbacks discussed above, by providing a headrest which does not include an independent frame or structural element integrated in an independent head piece, the headrest instead being an integral structural element that includes both the head piece and bars, all as a single piece preferably made of plastic injected on rigid cores or metal rods, or long rods of glass or carbon fiber, or composite materials, which are embedded in the rods, so that the entire independent manufacturing process of the frame or metal rods and the assembly is reduced to a single overmolding stage.

Specifically, the light headrest optimised with respect to production resources disclosed by the invention comprises a head piece and at least two bars, wherein said bars can be made by overmolding in plastic injected over at least two rigid cores respectively, where the headrest can be a single piece that can comprise the at least two bars and the head piece, so that the part can be manufactured in a single injection stage molding over the rods, obtaining as a result the entire piece able to pass the strength tests and with an optimum finishing and design for direct assembly.

Optionally, the headrest can comprise a union element that is part of the single structural body which joins the two bars and provides structural stability, and particularly allows and facilitates the distribution of the axial loads characteristic of accidents, braking maneuvers or any actions subjecting the headrest to reaction forces such as those resulting from head-on collisions or rear impacts, protecting passengers from whiplash and complying with the headrest efficiency specified by regulations.

Optionally, at least one quarter of the total length of the at least two rigid cores is inserted in the union element, so that the ends of said union element constitute the main supports that receive the loads in the form of insertion, instead of the head piece directly.

Optionally, the union element comprises, load distribution means in contact with at least one segment of the at least two metallic cores, which can allow a distribution of the load received by the bars along the entire width of the union element, which allows extending the lifetime of the headrest.

Optionally, the head piece can comprise support elements allowing passengers to rest their head on a body that can distribute pressure over the entire body of the head piece.

Optionally, the headrest can comprise rigid unions to increase the stiffness of the element and reduce the deformation of the headrest in case of impact, where said unions can be distributed throughout the headrest, allowing to distribute the pressures exerted by the axial loads produced by the passengers body, and specifically the head.

Optionally, the load distribution means can consist of ribs alternating with spaces without material, so that said ribs can remain loaded without increasing the internal pressure due to contact between them, thereby increasing the lifetime of the union of the rods and the plastic.

Optionally, the rigid unions can be alternated with spaces without material, as in the load distribution means.

Optionally, each of the at least two bars can be joined to the header at each of the at least two ends of the union element, to improve structural stability.

Optionally, the union element can be located between the head piece and the at least two bars, to prevent concentrating the loads.

Optionally, the at least two rigid cores can be longitudinal rods with a polygonal cross-section and rounded edges or with radii embedded along the at least two plastic bars, allowing the positioning of the rods in the mold, as well as their subsequent overinjection process.

Optionally, the headrest can comprise a longitudinal locking clip that can be coupled to at least one segment of the union element, allowing the attachment of a cover.

Optionally, each of the at least two bars can have notches made along their surface used to lock the headrest in a specific position with respect to the seat.

Optionally, the headrest can comprise at least one orifice allowing the attachment of the headrest to the seat. Optionally, the bars can be made by overmolding injected plastic on at least two rigid cores made of a material belonging to the group of metals, or a composite material made of at least two different materials, thereby conferring different properties to the headrest in case of collision.

A second aspect of the invention relates to a process for obtaining the light headrest optimised for production resources that enables injecting the overmolded material over at least two rigid cores, which comprises the following stages:

(i) coupling the at least two metallic rigid cores or cores of long glass or carbon fibers, or cores of composite materials inside the injection mold with the final shape of the headrest to prepare the injection of fused material in a single stage;

(ii) injecting the fused material in the mold and overmolding on the at least two rigid cores to form the entire headrest and achieve a specific final finish depending on the pressure of the injection flow;

(iii) opening the mold and extracting the finished headrest;

(iv) placing polymeric foam by injection or assembly in the empty spaces of the single-piece structural body, to cushion impacts and absorb the forces exerted on the headrest, as well as to supply stiffness to the piece.

Thus, according to the invention as described above, the system disclosed by the invention constitutes an improvement in both headrests and headrest frames hitherto employed, and solves the drawbacks discussed above in a fully satisfactory manner, eliminating the assembly stage by executing the headrest in a single piece and in a single stage, eliminating non-optimal material and assembly elements with the resulting weight reduction of one of the interior components of automobiles, achieving all of this by means of a simple design that does not entail difficulty in its execution or operators with specific skills.

### DESCRIPTION OF THE DRAWINGS

To complete the description being made, and in order to aid a better understanding of the characteristics of the invention according to an example of a preferred embodiment thereof, a set of drawings are provided that form an integral part of this description where, for purposes of illustration and in a non-limiting sense, the following is shown:

FIG. 1 is a perspective view of the rear part of the headrest with the clip (9), showing the load distribution means (6) and some rigid unions (8).

FIG. 2 is a perspective view of the front part of the headrest, showing the support elements (7) and the remaining rigid unions (8).

FIG. 3 is an enlarged cross-sectional view of one of the bars (3), showing one of the two rigid cores (4) embedded in one of said bars (3).

FIG. 4 is a plan view of the bottom part of the headrest, showing the embedded rigid cores (4).

FIG. 5 is a rear view of the headrest mounted on the rear support of an automobile seat with the bars (3) inserted in the guides.

### PREFERRED EMBODIMENT OF THE INVENTION

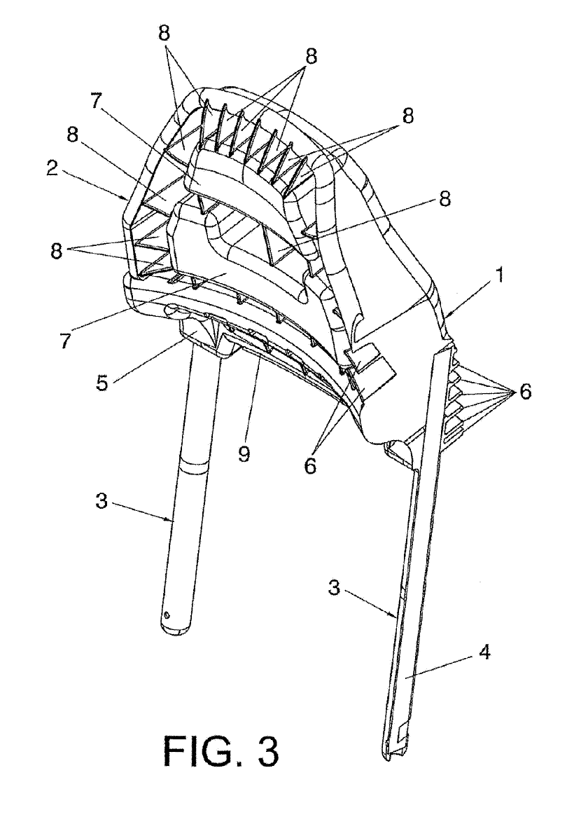

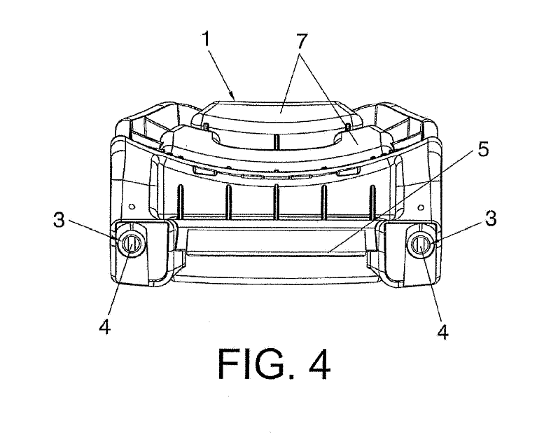

In view of the figures, it can be seen that in one of the possible embodiments of the invention the headrest in a single-piece structural body (1) in the form of a headrest, preferably for a seat, consisting of a head piece (2) that is preferably a headrest for an automobile seat, a union element (5) that is preferably an extension of the head piece (2), and two bars (3) that are preferably extensions in the form of a casing made of plastic injected over two rigid cores (4) that are preferably metallic rods with a rectangular cross-section, as can be seen in FIGS. 3 and 4.

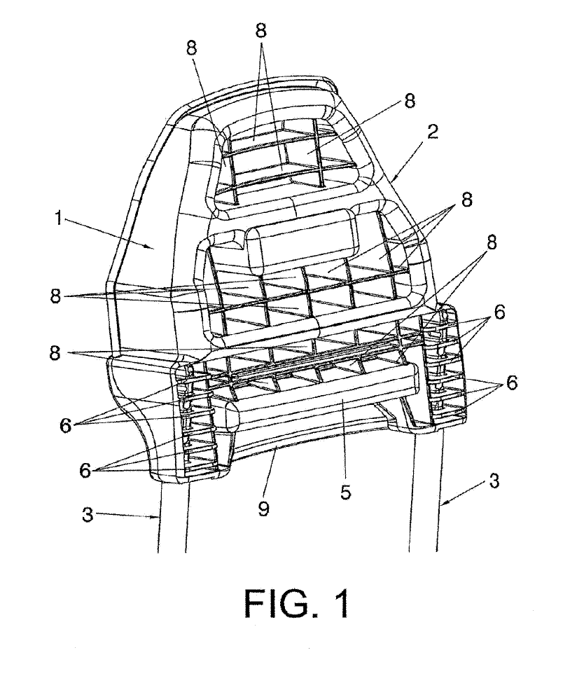

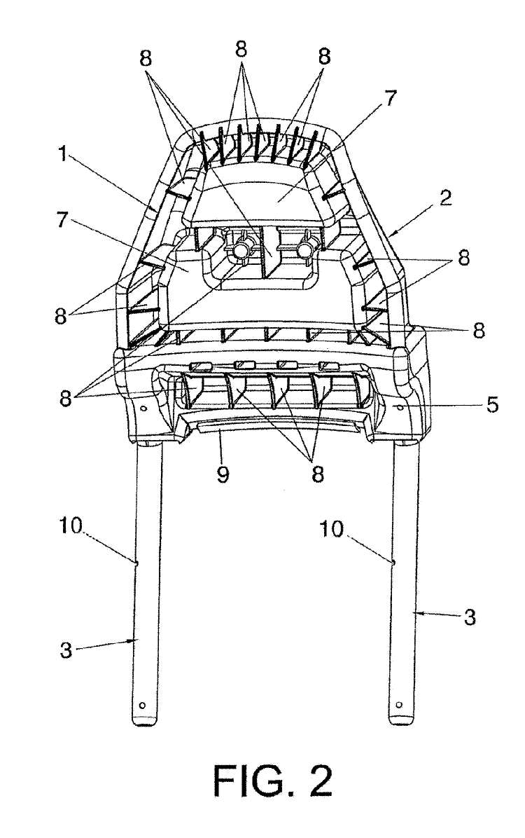

FIG. 1 shows how the union element (5) comprises at its ends some load distribution means (6) preferably placed on the segment of said union element (5) that preferably covers one third of the length of each of the two bars (3), where said distribution means are a row of horizontal ribs arranged longitudinally on said segment. The single-piece structural body (1) also comprises rigid unions (8) that are preferably some ribs arranged horizontally and vertically inside said structural body. In addition, said union element (5) preferably has a flat bottom segment that allows coupling a locking clip (9) which is preferably a longitudinal clip. FIG. 2 shows rigid unions (8) in the form of radial ribs preferably housed in an upper curved segment of the head piece (2), and two support elements (7) that are preferably two flat surfaces located in the central part of the head piece (1) level with the projection of the passengers head when it rests on the headrest.

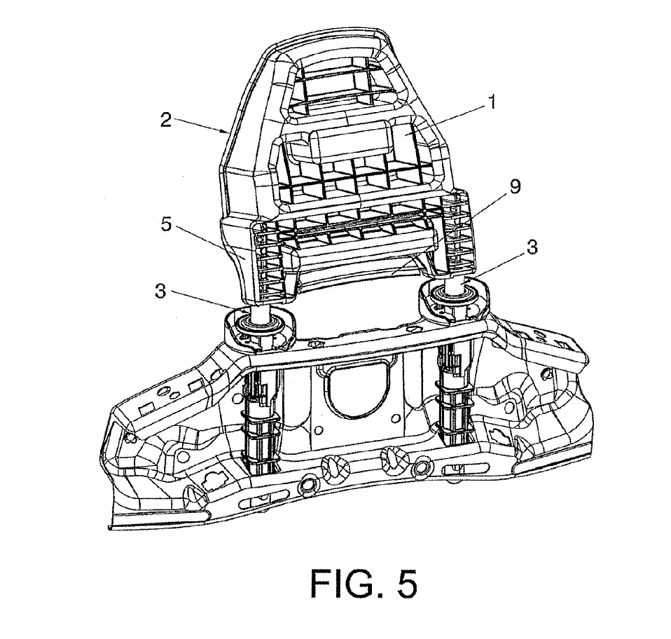

Finally, FIGS. 1 and 2 show preferably two locking notches (10) that are preferably two notches made in the midpoint of each of the two bars. These notches are preferably made during the injection process and allow joining the headrest to a seat frame using headrest guides, as shown in FIG. 5.

The assembly process is preferably performed in the following stages:

(i) coupling preferably two rigid cores (4) inside the injection mold which preferably has the final shape of the headrest;

(ii) injecting the fused material, preferably plastic, in the mold and overmolding on the rigid cores (4);

(iii) opening the mold and extracting the finished headrest;

(iv) placing, preferably mounting, polymeric foam in the empty spaces of the single-piece structural body.

1. Light headrest optimised for production resources, comprising a headrest and at least two bars, wherein said bars are made by overmolding with injected plastic over at least two rigid cores respectively, wherein the headrest is a single-piece body comprising the at least two bars and the head piece.

2. Light headrest optimised for production resources, according to claim 1, wherein the headrest comprises a union element that is part of the single-piece structural body.

3. Light headrest optimised for production resources, according to claim 2, wherein at least one quarter of the total length of the at least two rigid cores is embedded in the union element.

4. Light headrest optimised for production resources, according to claim 2, wherein the union element comprises load distribution means in contact with at least one segment of each of the at least two rigid cores.

5. Light headrest optimised for production resources, according to claim 1, wherein the head piece comprises support elements.

6. Light headrest optimised for production resources, according to claim 1, wherein the headrest comprises rigid unions.

7. Light headrest optimised for production resources, according to claim 4, wherein the load distribution means are ribs arranged alternating with spaces without material.

8. Light headrest optimised for production resources, according to claim 6, wherein the rigid unions are ribs arranged alternating with spaces without material.

9. Light headrest optimised for production resources, according to claim 2, wherein each of the at least two bars is joined to the head piece at each one of the at least two ends of the union element.

10. Light headrest optimised for production resources, according to claim 2, wherein the union element is located between the head piece and the at least two bars.

11. Light headrest optimised for production resources, according to claim 1, wherein the at least rigid cores are longitudinal rods with polygonal cross section embedded along the at least two plastic bars.

12. Light headrest optimised for production resources, according to claim 2, wherein it comprises a locking clip.

13. Light headrest optimised for production resources, according to claim 1, wherein each of the at least two bars has locking notches made along its surface.

14. Light headrest optimised for production resources, according to claim 1, wherein the bars are made by overmolding with injected plastic over at least two rigid cores made of a material belonging to the group of metals, or a material made of at least two different materials.

15. Light headrest optimised for production resources in which the overmolded material is injected over at least two rigid cores, wherein it comprises the following steps:
(i) coupling the at least two rigid cores inside the injection mold with the final shape of the headrest;
(ii) injecting the fused material in the mold and overmolding on the at least two rigid cores;
(iii) opening the mold and extracting the finished headrest;
(iv) placing polymeric foam in the empty spaces of the single-piece structural body.
